(19) United States
(12) Patent Application Publication
(10) Pub. No.: US 2012/0274233 A1
(43) Pub. Date: Nov. 1, 2012

(54) CONSTANT CURRENT LED DRIVER

(75) Inventors: Yinming Chen, Palo Alto, CA (US); Web Chang, Taipei City (TW)

(73) Assignee: Sequoia Microelectronics Corporation, Taipei City (TW)

(21) Appl. No.: 13/094,852

(22) Filed: Apr. 27, 2011

(51) Int. Cl. H05B 37/02

(52) U.S. Cl. 315/294; 315/291

(57) ABSTRACT

A constant current LED driver comprising an LED driver to supply constant current to an LED circuit provided with a protection element, an open loop sensor to sense the open loop of the LED circuit and a clamping control to maintain the voltage in the LED circuit at a predetermined level. The open loop sensor may be a high voltage detector. The clamping control controls the power supplied to the LED circuit in response to the detection signals of the open loop sensor. In one embodiment, the clamping control controls the power supplied to the LED circuit according to the power of the detection signals.

### FIELD OF THE INVENTION

The present invention relates to a constant current LED driver, especially to an LED driver that supplies the constant current to an array of LED, with an open loop detector and an output voltage clamping function.

### BACKGROUNDS OF THE INVENTION

As the LED has become a popular light source for the illumination and displaying systems, all kinds of applications using the LED as the light source have been developed. For this industry, it is well-known that an LED driver must provide the function of supplying a constant current to the LED array or matrix.

FIG. 1 shows the circuit diagram of an LED array and a conventional constant-current LED driver to drive the LED array. As shown in the figure, a plurality of LEDs, LED1, LED2, LED3, etc. is connected in series, in the form of an array, and a voltage YIN supplies currents to the array of LED. In the figure, a ripple filter capacitor C1 is provided in parallel to the LED array to reduce the ripple voltage across the LED array.

The driver circuit for the LED array includes a comparator COM1, with its inputs being a first reference voltage Vref1 and the voltage between the inductor L and the sense resistor R, an RS flip-flop logic RS with its inputs being the clock signals of the clock CL, a driver DR, a transistor Q0 and a diode D1 in parallel connection with the LED array.

The operation of this LED driver consists of two phases. In phase 1, the power is added between the input VIN and the ground GR. A current flows through the LED array, the inductor L, the transistor Q0 and the sense resistor R1 to the ground. In phase 1, the voltage VR1 across resistor R1 will ramp up when the current goes through resistor R1, until the voltage VR1 is greater then the first reference voltage Vref1, at which time the comparator COM1 will generate a signal to the RS flip-flop logic RS to actuate the driver DR, which in turn turns off the transistor Q0. When this happens, the state is shifted to phase 2 wherein the current will flow in the loop of the LED array, the capacitor C1, the inductor L and the diode D1.

The conventional constant current driver uses the above-described or similar circuits to maintain the voltage, and therefore the currents, supplied to the LED array in constant values.

In the conventional constant current LED driver, however, the ripple filter capacitor C1 tends to explode, when the LED circuit is an open loop and a high voltage from input is applied across the capacitor C1. To be more specific, this capacitor C1 is provided to reduce the ripple of the current. The capacitor C1, however, has a limit in the voltage rate. When the LED circuit is open, the transistor Q0 will pull the low side of the capacitor C1 to close to ground. The high voltage that crosses the capacitor C1 will cause the explosion of the capacitor C1.

To solve this problem, many researchers have proposed their solutions. Among them, the Japanese laid-open patent No. JP 2006 108519 by Nakase et al. discloses an LED lighting drive circuit to prevent increase of current due to failure in an LED array. A normal operation current detecting circuit detects an open in the constant current loop, upon which detection the reference voltage level is lowered so to lower the constant current level of the LED drive circuit. The circuit disclosed in this laid-open patent, however, is complicated. In addition, the reference voltage value of the drive circuit in this laid-open patent is determined by the number of the LEDs in the array. Therefore, adjustments to the circuit before using are necessary.

It is thus necessary to provide a constant current LED driver that can prevent the explosion of the device when the LED circuit is an open loop.

It is also necessary to provide a simplified constant current LED driver that can prevent the explosion of the device when the LED circuit is an open loop.

It is also necessary to provide a constant current LED driver that is able to detect the open loop of the LED circuit and protect the LED circuit.

It is also necessary to provide a constant current LED driver that is able to maintain the voltage across the LED circuit at a predetermined level.

### OBJECTIVES OF THE INVENTION

The objective of this invention is to provide a constant current LED driver that can prevent the explosion of the device when the LED circuit is an open loop.

Another objective of this invention is to provide a simplified constant current LED driver that can prevent the explosion of the device when the LED circuit is an open loop.

Another objective of this invention is to provide a constant current LED driver that is able to detect the open loop of the LED circuit and protect the LED circuit.

Another objective of this invention is to provide a constant current LED driver that is able to maintain the voltage across the LED circuit at a predetermined level.

### SUMMARY OF THE INVENTION

According to the present invention, a novel constant current LED driver is disclosed. The constant current LED driver of this invention includes an LED driver to supply constant current to an LED circuit provided with a protection element, an open loop sensor to sense the open loop of the LED circuit and a clamping control to maintain the voltage in the LED circuit at a predetermined level.

In the preferred embodiments of this invention, the protection element comprises a capacitor. In some embodiments of this invention, the LED circuit comprises a power supply and an LED array. The LED array comprises at least one LED.

In a preferred embodiment of this invention, the open loop sensor comprises a high voltage detector. The open loop sensor generates a high voltage detection signal, when the voltage detected exceeds a predetermined value. The high voltage detection signal may be an analog signal. Preferably the open loop sensor comprises a signal transmitter, to transmit the high voltage detection signal. In one preferred embodiment, the signal transmitter is a light emitter. The open loop sensor may be connected in parallel with the LED circuit. In a preferred embodiment, the open loop sensor is connected in parallel with the protection element.

Also in a preferred embodiment of this invention, the clamping control generates a first control signal in response to the high voltage detection signal of the open loop sensor. In such an embodiment, the first control signal of the clamping control shuts OFF the power supplied to the LED circuit. In another preferred embodiment, the clamping control generates a second control signal, when the high voltage detection signal does not exist. The second control signal resumes the power supplied to the LED circuit. The clamping control circuit may further include a signal receiver, to receive the high voltage detection signal of the open loop sensor. In one embodiment, the signal receiver is a light detector.

In a preferred embodiment of this invention, the signal transmitter of the open loop sensor and the signal receiver of the clamping control comprise a photo coupler. In some embodiments of this invention, the clamping control is connected to the LOW side of the LED circuit.

In the preferred embodiments of this invention, the clamping control circuit generates the first control signal, when the power of the high voltage detection signal is higher than a predetermined value and generates the second control signal, when the power of the high voltage detection signal is lower than the predetermined value. In such embodiments, the clamping control may include a voltage detector and a comparator with its inputs being the output of the voltage detector and a second reference voltage.

These and other objectives and advantages of this invention may be clearly understood from the following detailed description by referring to the following drawings.

### BRIEF DESCRIPTION OF THE DRAWINGS

FIG. 1 shows the circuit diagram of an LED array and a conventional constant-current LED driver to drive the LED array.

FIG. 2 shows the block diagram of the invented constant current LED driver.

FIG. 3 shows the circuit diagram of one embodiment of the invented constant current LED driver.

### DETAILED DESCRIPTION OF THE INVENTION

The present invention discloses a new structure of the constant current LED driver. The invented LED driver supplies constant currents to an LED array with a protection element, detects an open loop in the LED array and maintains the level of voltage supplied to the LED array.

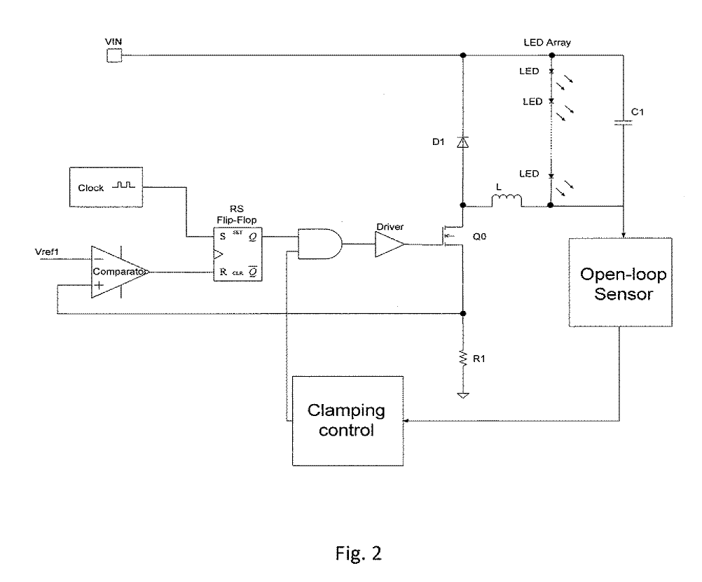

FIG. 2 shows the block diagram of the invented constant current LED driver. As shown in this figure, the invented constant current LED driver comprises an LED driver circuit 20, an open loop sensor circuit 30 and a clamping control circuit 40 and is in connection with an LED circuit 10, comprising a power supply 13, an LED array 11 and a protection element 12.

In general cases, the power supply 13 is a direct current (DC) power supply. In the application of this invention, the quantity of the LEDs in an LED array is not limited to any number. In general applications, the number of the LEDs varies from 1 to hundreds. Not like in the conventional art, the number of the LEDs that a driver can drive is not related to the voltage settings of the driver. It is not necessary to determine the “normal” values of the current or voltage supplied to the LED array according to the structure of the circuit and/or the working voltage of the LEDs and/or the number of the LEDs.

Also in the application of this invention, the LEDs may be connected in parallel or in series. It is also possible to use the present invention in an LED matrix, in which the LEDs are connected in series to form arrays that are connected in parallel. The working current and/or voltage of the LEDs are not any technical limitation to this invention.

The LED driver circuit 20 may be any constant current controller that is commercially available in the market. In general, it may include a feedback controller that maintains the voltage supplied to the LED circuit 10 at predetermined levels, according to the voltage detected at the LED circuit 10. In the preferred embodiments, the LED driver circuit 20 includes a comparator with its inputs being a reference voltage and the voltage detected at the LED circuit 10 and a switch to control the power supplied to the LED circuit 10. The LED driver circuit 20 shuts OFF the power, when the voltage at the LED circuit 10 is higher than the reference voltage. The value of the reference voltage may be determined by the user in accordance with the applications and the structure of the LED circuit 10 and/or the LED driver.

In an embodiment of this invention, the open loop sensor 30 comprises a high voltage detector. In the preferred embodiments, the high voltage detector is connected in parallel with the protection element, to detect a high voltage at the protection element. Also in the preferred embodiments, the high voltage detector may be a resistor. The open loop sensor 30 generates a high voltage detection signal, when the voltage detected exceeds a predetermined value. The high voltage detection signal may be an analog signal. In such an embodiment, the high voltage detection signal may be an optical signal. Preferably the open loop sensor 30 comprises a signal transmitter, to transmit the high voltage detection signal. In one preferred embodiment, the signal transmitter is a light emitter. The open loop sensor may be connected in parallel with the LED circuit 10.

In the embodiments of this invention, the clamping control circuit 40 generates a first control signal in response to the high voltage detection signal of the open loop sensor 30. In such an embodiment, the first control signal of the clamping control 40 shuts of the power supplied to the LED circuit. Also in the embodiments of this invention, the clamping control 30 generates a second control signal in the absence of the high voltage detection signal. The second control signal resumes the power supplied to the LED circuit 10. The clamping control circuit 30 may further include a signal receiver, to receive the high voltage detection signal of the open loop sensor 30. When the high voltage detection signal is an optical signal, the signal receiver may be a light detector, whereby the signal transmitter of the open loop sensor and the signal receiver of the clamping control comprise a photo coupler. In some embodiments of this invention, the clamping control 40 is connected to the LOW side of the LED circuit. In the preferred embodiments of this invention, the clamping control circuit 40 generates the first control signal, when the power of the high voltage detection signal is higher than a predetermined value and generates the second control signal, when the power of the high voltage detection signal is lower than the predetermined value. One important feature of this invention is that the predetermined value is not relevant to the number of the LEDs in the array and/or the working voltage/current of the LEDs.

An exemplary embodiment of the constant current LED driver according to this invention will be described in the followings, to illustrate the basic concepts of this invention.

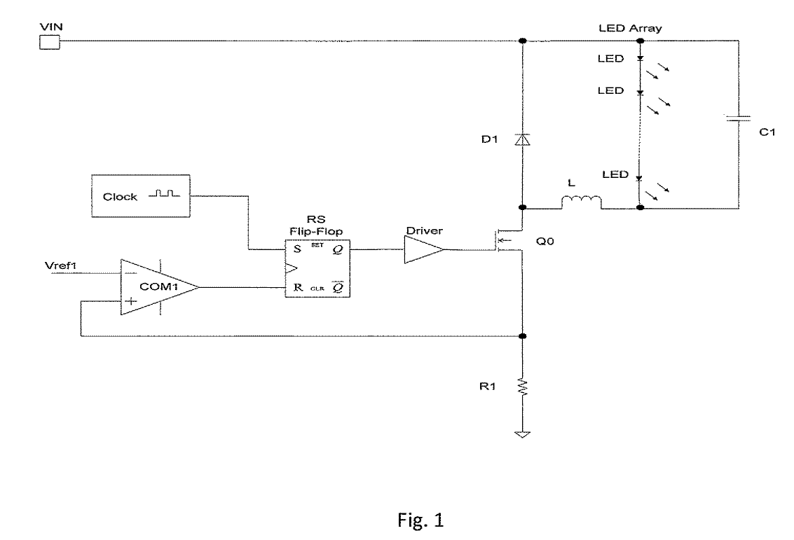

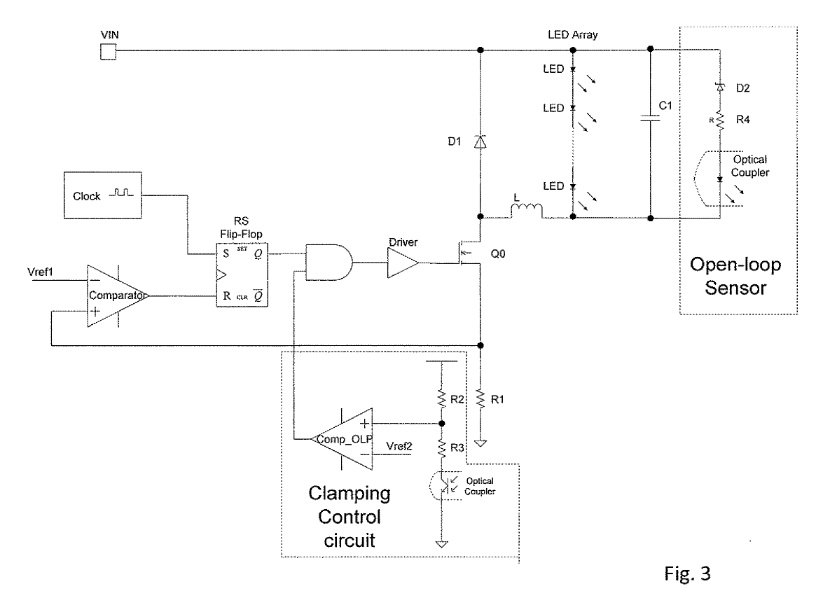

FIG. 3 shows the circuit diagram of one embodiment of the invented constant current LED driver. In this drawing, an LED circuit 10 and the constant current LED driver of this invention are shown. Also in this figure, the elements that are the same as those in FIG. 1 are labeled with the same reference numbers.

The LED circuit 10 shown in FIG. 3 includes an array (11) of 3 LEDs, LED1, LED2 and LED3 connected in series, a voltage VIN supplying electric power to the LED array 11, a ripple filter capacitor C1 connected in parallel to the LED array to function as the protection element and an inductor L and a sense resistor R1 connected in series with each other and with the LED array 11. The LED driver of the embodiment includes a driver circuit 20 to supply constant currents, an open loop sensor 30 to detect the open loop of the LED circuit and a clamping control 40 to maintain the voltage supplied to the LED circuit at a predetermined level.

As shown in this figure, the LED driver circuit 20 includes a comparator COM1, with its inputs being a first reference voltage Vref1 and the voltage between the inductor L and the sense resistor R, an RS flip-flop logic RS with its inputs being the clock signals of the clock CL and the output of the comparator COM1, a driver DR, a transistor Q0 and a diode D1 in parallel connection with the LED array. In the case where the LED array 11 includes 3 LEDs, the value of the first reference voltage Vref1 may be, e.g., 0.25V. Of course, this value may be determined by those skilled in the art according to the structure and other features of the LED circuit 10 and/or the constant current driver.

In this embodiment of this figure, the open loop sensor 30 includes a resistor R4, preferably a limited current resistor, as the high voltage detector, a diode D2, preferably a Zener diode, to rectify the current and a light emitter 31, to function as the signal transmitter of the high voltage detection signal. The open loop sensor 30 generates an open-loop signal, in this ease, the high voltage detection signal, when the LED array 11 is an open loop. The LED array 11 is an open loop, when one or more than one of the LEDs LED1, LED2 and LED3, is mal-functioned or does not exist.

The clamp control circuit 40 includes a pair of resistors R2 and R3 forming a resistor divider in connection with a light detector 41 that works as receiver of the high voltage detection signal, a comparator 42 with its inputs being a second reference voltage and the voltage between the resisters R2 and R3 and an AND gate 43 with its inputs being the output of the comparator 42 and the output of the RS flip-flop logic RS (of the LED driver circuit 20). The light detector 41 and the light emitter 31 form a pair of the optical coupler. In an application wherein the number of the LEDs is 3 and the working voltage of the LEDs is 3.5V, the second reference voltage may be set to 1.25 V. Of course, those skilled in the art may determine the value of the second reference voltage according to the applications and/or the structure of the LED circuit 10 and the LED driver circuit and/or other features of the system.

The operations of the invented constant current LED driver will be described in the followings. When the LED array is an open loop for any reason, the voltage across the capacitor C1 will go up. When the voltage at the capacitor C1 is higher than the voltage set by the diode D2 which may be a Zener diode, the resistor R4 and the light emitter 31, the current of the light emitter 31 will increase tremendously, therefore light will emit from the light emitter 31. The light emitted by the light emitter 31 will be detected by the light detector 41, whereby the voltage node 44 between resistors R2 and R3 will be pulled low. When the voltage of the node 44 is lower than the voltage of the second reference voltage Vref2, in this case 1 volt, the comparator 42 generates a “low” signal to the AND gate 43, whereby the driver DR shuts OFF the transistor Q0. When this happens, the voltage across the capacitor C1 will stop to pullhigh. The voltage of the capacitor C1 is approximate to the Zener reference voltage plus the voltage VR4 and the voltage across the light emitter. In the preferred embodiment of this invention, the second reference voltage Vref2 is set to be lower than the set voltage 1.25V, therefore, the capacitor is protected from explosion.

When for any reason, the LED array 11 is not an open loop, the voltage across the capacitor C1 is not pulled high, therefore the current of the light emitter 31 is not sufficient to driver the light emitter 31. In this case, the light detector 41 does not pull low the voltage node 44, whereby the comparator 42 does not generate the “low” signal to the AND gate 43. Therefore, the transistor Q0 is turned ON, to supply power to the LED circuit 10.

As shown above, the invented constant current LED driver does not only supply constant currents to the LED array but also provides an open loop detection function and a voltage clamping control function for the LED circuit. In the present invention, the open loop sensor detects the voltage at the protection element, not at the LED array. The value of the second reference voltage is not related to the number/working voltage/working current of the LED array, therefore, it is not necessary to design or adjust the settings in accordance with the number of the LED array or the working voltage/current of the LEDs. The circuit of this invention is simple and easy to fabricate.

As the present invention has been shown and described with reference to preferred embodiments thereof, those skilled in the art will recognize that the above and other changes may be made therein without departing form the spirit and scope of the invention.

What is claimed is:

1. A constant current LED driver, comprising an LED driver to supply constant current to an LED circuit provided with a protection element, an open loop sensor to sense the open loop of the LED circuit and a clamping control to maintain the voltage in the LED circuit at a predetermined level.

2. The constant current LED driver according to claim 1, wherein the protection element comprises a capacitor.

3. The constant current LED driver according to claim 1, wherein the LED circuit comprises a power supply and an LED array comprising at least one LED.

4. The constant current LED driver according to claim 1, wherein the open loop sensor comprises a high voltage detector to generate a high voltage detection signal, when the voltage detected exceeds a predetermined value.

5. The constant current LED driver according to claim 4, wherein the high voltage detection signal is an analog signal.

6. The constant current LED driver according to claim 1, wherein the open loop sensor further comprises a signal transmitter, to transmit the high voltage detection signal.

7. The constant current LED driver according to claim 6, wherein the signal transmitter is a light emitter.

8. The constant current LED driver according to claim 1, wherein the open loop sensor is connected in parallel with the LED circuit.

9. The constant current LED driver according to claim 8, wherein the open loop sensor is connected in parallel with the protection element.

10. The constant current LED driver according to claim 1, wherein the clamping control generates a first control signal in response to the high voltage detection signal of the open loop sensor, to shut OFF the power supplied to the LED circuit.

11. The constant current LED driver according to claim 1, wherein the clamping control generates a second control signal, to resume the power supplied of the LED circuit, when the high voltage detection signal does not exist.

12. The constant current LED driver according to claim 1, wherein the clamping control circuit further comprises a signal receiver, to receive the high voltage detection signal of the open loop sensor.

13. The constant current LED driver according to claim 12, wherein the signal receiver is a light detector.

14. The constant current LED driver according to claim 1, wherein the signal transmitter of the open loop sensor and the signal receiver of the clamping control comprise a pair of photo couplers.

15. The constant current LED driver according to claim 1, wherein the clamping control is connected to the LOW side of the LED circuit.

16. The constant current LED driver according to claim 1, wherein the clamping control circuit generates a first control signal, when the power of the high voltage detection signal is higher than a predetermined value and generates a second control signal, when the power of the high voltage detection signal is lower than the predetermined value.

17. The constant current LED driver according to claim 16, wherein the clamping control comprises a voltage detector and a comparator with its inputs being the output of the voltage detector and a second reference voltage.
